(19) United States
(12) Patent Application Publication
(10) Pub. No.: US 2004/0073581 A1
(43) Pub. Date: Apr. 15, 2004

(54) Version controlled associative array

(76) Inventors: Lawrence W. McVoy, San Francisco, CA (US); Andrew W. Chang, Los Altos, CA (US); Wayne H. Scott, Churubusco, IN (US)

Correspondence Address: Benjamin T. Queen, II, Pietragallo, Bosick & Gordon, One Oxford Centre, 301 Grant Street, 38th Floor, Pittsburgh, PA, 15219, US

(21) Appl. No.: 10/607,871

(22) Filed: Jun. 27, 2003

Related U.S. Application Data
(60) Provisional application No. 60/392,221, filed on Jun. 27, 2002.

(51) Int. Cl. G06F 12/00

(52) U.S. Cl. 707/203

(57) ABSTRACT

A version controlled associative array is provided. A method of the invention includes providing a version control system on a computer, creating within the version control system an associative array comprising a collection of keys and corresponding values, applying a version control operation to the associative array to version control the collection of keys and corresponding values, and applying a version control operation to a collection of associative arrays, each viewed as a database record, and organized as a group of database tables forming a database. An apparatus, a computer system, and a computer readable medium pertaining to the version controlled associative array invention are also provided.

### CROSS REFERENCE TO RELATED APPLICATION

This application claims the benefit of U.S. Provisional Application No. 60/392,221 filed Jun. 27, 2002, the contents of which are hereby incorporated by reference.

### FIELD OF THE INVENTION

The present invention relates generally to version control and/or databases, and specifically to a version control system for controlling an associative array.

### BACKGROUND INFORMATION

A group of software developers working together to create a product often runs into the problem of coordinating their work. Changes are made which overwrite other changes. Versions of the system which functioned well are overwritten with versions containing buggy new features. Bugs found in prior versions are hard to track down because the prior versions are no longer available. To aid in reducing the cost of having these problems, version control systems are used.

Referring to FIG. 1a, a typical version control system (120) is made up of one or more repositories (100) each of which is related to one or more file system workspaces (110). Workspaces are file system hierarchies made up of files, directories, and symbolic links. Users give requests (140) to the version control system to modify the files, directories, or symbolic links by the check-out operation. After modifications are done, the user does a check-in operation to store the modifications in the repository. At some time the user commits the change allowing others who have access to the repository (100) to make use of the new change in other workspaces. The repositories act like a vault storing work which has been done. The workspaces are a place to view existing versions, develop new versions, and merge new versions with versions created by others.

The version control system enables the user to be able to go back in time to recover an earlier state of the workspace. This may be done because the current version has some problem and an earlier version did not. Or a problem was reported relating to an earlier version, and the user wants to understand the problem in the context of the earlier version.

The version control system also enables a user to gain understanding on how the current version evolved to its current state. This can be done by giving requests (140) to have the version control system (120) generate a variety of reports (150). These reports can be in graphical form showing the historical progression of versions in the system, or a textual report showing who made the changes to a particular version, when that user made the change and any comment entered at the time to document why the change was made. These reports are as valuable to the users of the system as being able to recover earlier versions of items controlled by the system.

The reports combine data (information under version control) and meta data (information about the information under version control). Examples of meta data are change author, change date, change revision, and computer host name on which the change was done. An example report might be to list all change revisions and the associated comments for work done by “Bob Jones” between May 5, 2000 and Jun. 12, 2001. Examples of a combination report is an annotated file listing which lists each line in the file prepended by a selection of meta data, such as author and revision of that line.

Advanced version control can replicate repositories facilitating development in a geographically distributed environment. This is shown, for example, in FIG. 1b, with the initial repository A (160) replicated in B (170). Each repository now functions in a separate independent version control system described in FIG. 1a. The repositories can be in the same computer or be in different computers that are connected by a network (179). Methods are supported to combine work done in the replicated repositories and resolve conflicts that may happen.

Some version control systems have the ability to group changes to files. FIG. 1c shows a project (180) made up of a group of files (181-185). A particular changeset (186) affects 4 of those files, creating one (185), deleting one (184), and modifying two (182, 183). The changeset also records the version of the unchanged files (181) at the time of the changeset.

Some version control systems track the state of all the files in a project under version control at the time of a change is committed. This allows a complete rollback, to see not only the changes that occurred, but also the corresponding state of the unchanged part of the system.

Some version control systems maintain history in the form of an acyclic directed graph showing branches and merges. FIG. 1d shows a sample graph where each changeset (190-198) captures the state of the version, allowing for complete rollback ability to any point in the history graph where a changeset was made.

What is lacking in a typical version control system is the ability to version control the structures inside of a file, such as files containing configurations, personal address books, or product defect reports. This limits the version control system's ability to merge work done in different workspaces, and generate reports about changes to specific entries inside a file.

The present invention addresses this weakness in existing systems by focusing on one particular form of user data from which more complex data structures can be built: information structured as a set of entries with each entry having two components: a key and a value. This describes a commonly known data structure called an associative array.

An associative array is a well-known data structure for holding information in the desired form of key and value. The restriction is that each key name in an associative array must be unique relative to other keys in the same associative array. For example, it is not possible to have two keys called “NAME”. FIG. 2a shows an associative array which contains 5 keys. While the table shows the entries in a particular ordering: NAME, ADDRESS, NOTES, PHONE, PIC, ordering does not matter. It could be equivalently listed as ADDRESS, NAME, PIC, PHONE, NOTES and so forth. FIG. 2b shows common operations that can be done on an associative array.

There is identified, therefore, a need for an improved version control system that overcomes disadvantages, limitations and/or shortcomings of known version control systems.

### SUMMARY OF THE INVENTION

An aspect of the present invention is to provide, on a computer capable of implementing version control, a method comprising providing a version control system on the computer, creating within the version control system an associative array comprising a collection of keys and corresponding values, and applying a version control operation to the associative array to version control the collection of keys and corresponding values.

Another aspect of the present invention is to provide an apparatus for implementing version control comprising means for providing a version control system, means for creating within the version control system an associative array comprising a collection of keys and corresponding values, and means for applying a version control operation to the associative array to version control the collection of keys and corresponding values.

A further aspect of the present invention is to provide a computer system capable of implementing version control comprising a processor and a memory in communication with the processor, wherein the memory has stored thereon a set of data and instructions including a version control system which, when executed by the processor, cause the processor to perform certain steps. These steps may include creating within the version control system an associative array comprising a collection of keys and corresponding values, and applying a version control operation to the associative array to version control the collection of keys and corresponding values.

An additional aspect of the present invention is to provide a computer system comprising a first user computer and a second user computer that is networked with the first user computer. Each of the first user computer and the second computer are capable of operating independently in a peer-to-peer environment. Specifically, the first user computer comprises a first version control system, means for creating within the first version control system an associative array, and means for applying a version control operation to the associative array. The second user computer comprises a second version control system, means for creating within the version control system an associative array, and means for applying a version control operation to the associative array.

Yet a further aspect of the present invention is to provide a computer readable medium having stored thereon instructions which when executed by a processor, cause the processor to perform the steps of implementing a version control system on the computer readable medium, creating within the version control system an associative array comprising a collection of keys and corresponding values, and applying a version control operation to the associative array in order to version control the collection of keys and corresponding values.

These and other aspects of the present invention will be more apparent from the following description.

### BRIEF DESCRIPTION OF THE DRAWINGS

FIGS. 1a-1d are diagrams showing components of a typical version control system and an advanced version control system.

FIG. 2a shows an example of a typical associative array.

FIG. 2b shows typical operations that can be performed on an associative array.

FIG. 3 is a diagram showing the storing of an associative array in a single file.

FIG. 4 shows version control operations applied to an associative array.

FIG. 5 shows version control operations applied to a plurality of associative arrays.

FIGS. 6a-6h show various aspects of organizing a collection or plurality of associative arrays as a version controlled database.

FIG. 7 shows executing a query on a version controlled database table.

FIGS. 8a-8e shows various aspects of the merging of parallel changesets.

FIGS. 9a and 9b shows two machines connected by a computer network and the process of creating independent work and merging.

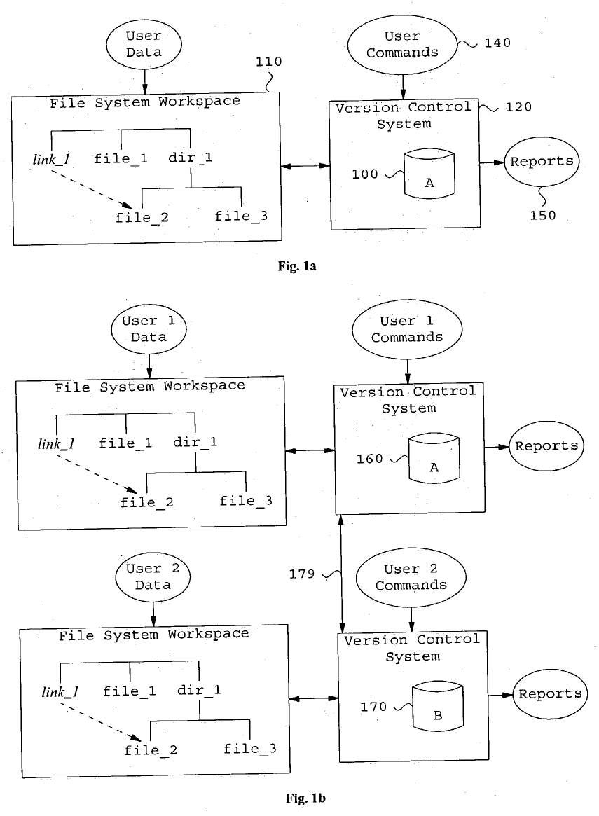

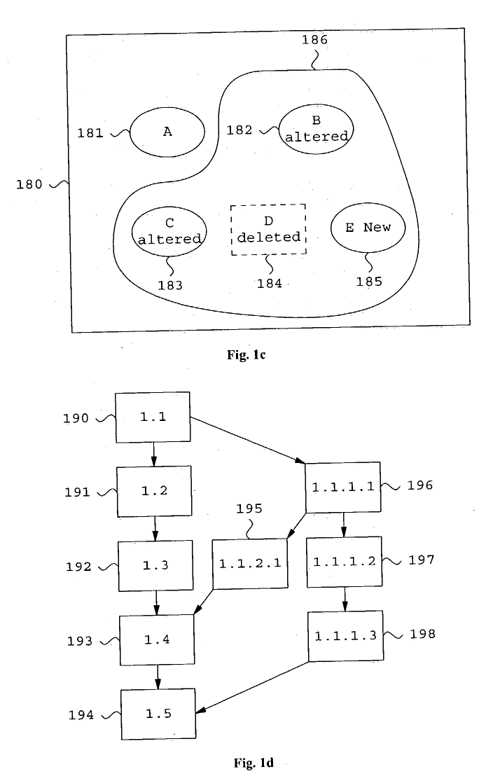

### DETAILED DESCRIPTION

Version control systems typically are used to manage files, directories, and symbolic links to files and directories. The present invention improves on known version control systems by adding associative arrays as a type of version controlled entity. Common version control operations are described such as, for example, check out, check in, branch and merge, report generation, and peer-to-peer replication.

Referring to the figures appended hereto, embodiments of the invention will be described in detail herein. It is to be understood that the figures and descriptions set forth herein of the present invention have been simplified to illustrate elements that are relevant for a clear understanding of the present invention, while eliminating, for purposes of clarity, other elements that may be typically found in a version control system and/or a computer or computer network capable of implementing a version control system: For example, specific operating system details and modules are not shown. Also, specific network items, such as network routers, are not shown. Those of ordinary skill in the art will recognize that other elements may be desirable to produce an operational system incorporating the present invention. However, because such elements are well known in the art, and because they do not facilitate a better understanding of the present invention, a discussion of such elements is not provided herein.

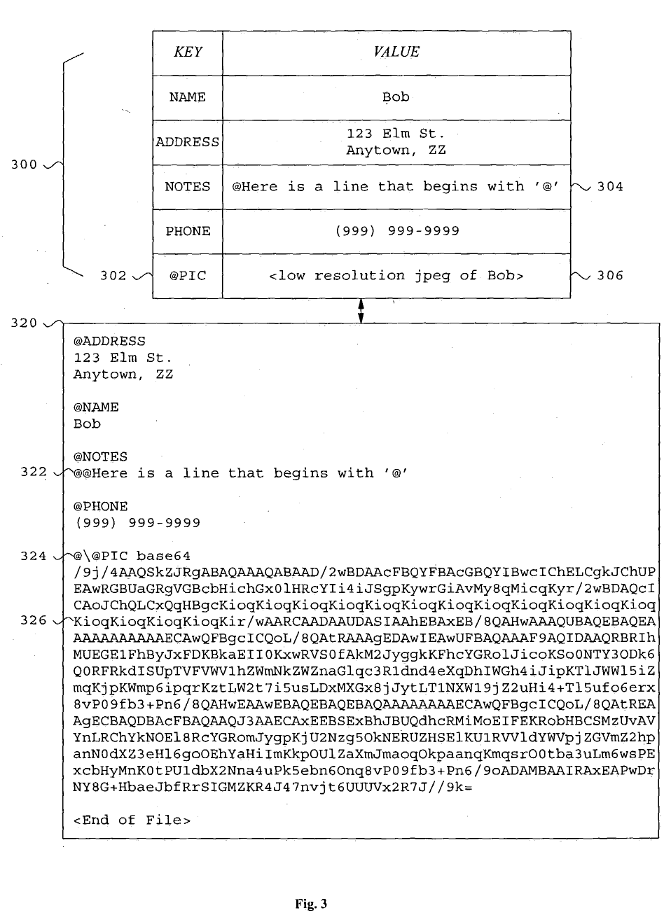

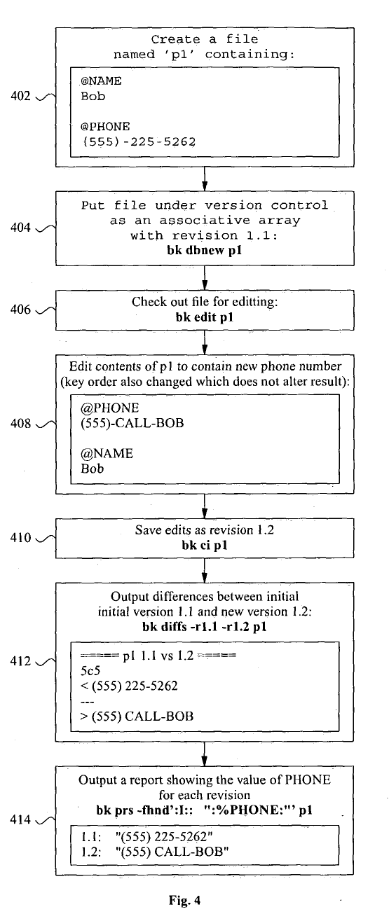

Referring to FIG. 3, there is illustrated an embodiment of the invention for structuring of an associative array (300) in a single file (320). This structuring may be done using, for example, known methods such as XML and YAML. In one embodiment, each key appears on its own line, prepended by an atsign (‘@’). Each value then appears on multiple lines up to the line containing the next key. If a data line begins with an atsign (‘@’) (304), then an extra atsign (‘@’) is prepended (322). If a key begins with an atsign (302), then it is prepended by a backslash (324). If a value has binary data (306), then that data is encoded in as base64 (326). It will be appreciated, however, that in accordance with the invention the file (320) may be structured in numerous ways or that different symbols may be utilized to prepend the keys and values that comprise the associative array (300).

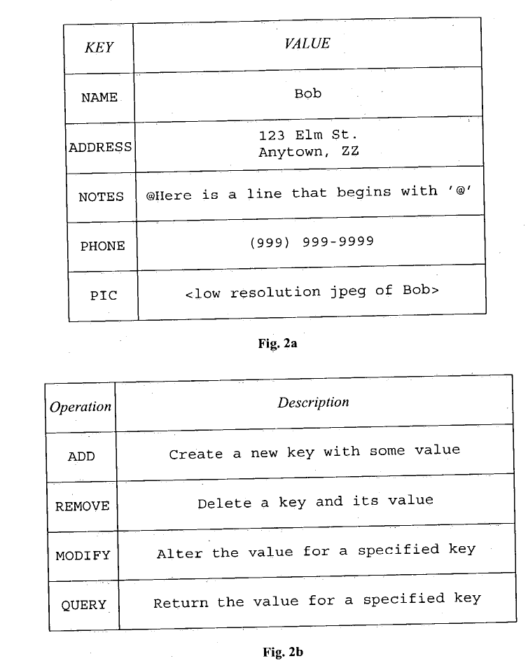

Referring to FIG. 4, there is illustrated various operations that can be performed on an associative array file that is created at (402) and put under version control at (404). It will be appreciated that typical version control operations, such as illustrated in FIG. 2b, as well as other typical operations such as, for example, create, edit, delete, commit, merge, rollback, delta or annotate, may be performed on the associative array file while under version control.

After the file is under version control at (404), it is available to be modified by checking it out for editing (406). In one embodiment, changing the key's order in the file does not result in change being recorded. The example shows the value of PHONE being changed (408). When the idits are done, the file is checked in (410) using methods, for example, that are typical in version control systems for performing such operations.

The difference between any two versions stored in the version control system can be computed (412). The output box shown in (412) shows that changing the order of the keys did not contribute to the change that was stored. In addition, reports can be generated combining version history and other meta data, with the keys' values stored in each version. The report generated in (414) lists the value of PHONE for each version stored.

FIG. 4 illustrates operations on one associative array stored in a structured file. In addition, the present invention provides for all the operations shown in FIG. 4, as well as other version control operations set forth herein, to be performed on a collection or plurality of files such as, for example, a collection or plurality of associative array files organized as a database table.

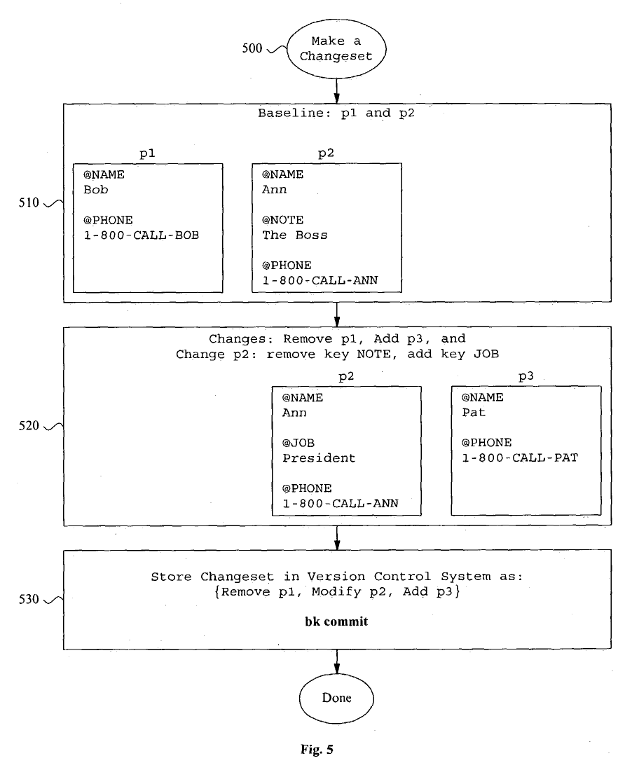

FIG. 5 shows additional operations on a collection of associative array files P1, P2, etc. A changeset is made (500) which captures changes across many associative arrays, including removing files, adding new files and modifying existing files. (510) shows the state of 2 associative array files P1 and P2 at some point in time. Changes are then made resulting in (520). The changes are then committed in a changeset, creating a new baseline (530). A changeset captures both the changes down to each file altered by the changeset as well as the version of all other files under version control, but not changed by the changeset. Advantageously, this means that each changeset also captures the version of each file under version control before the changeset was made.

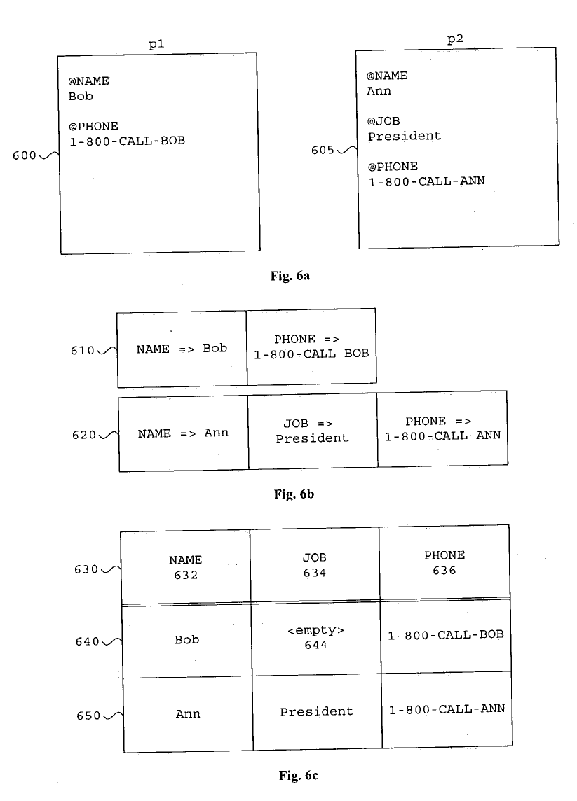

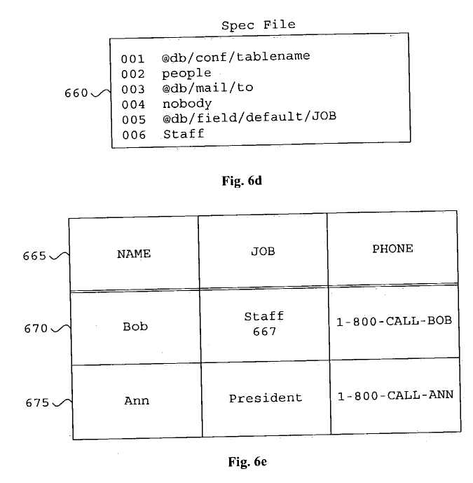

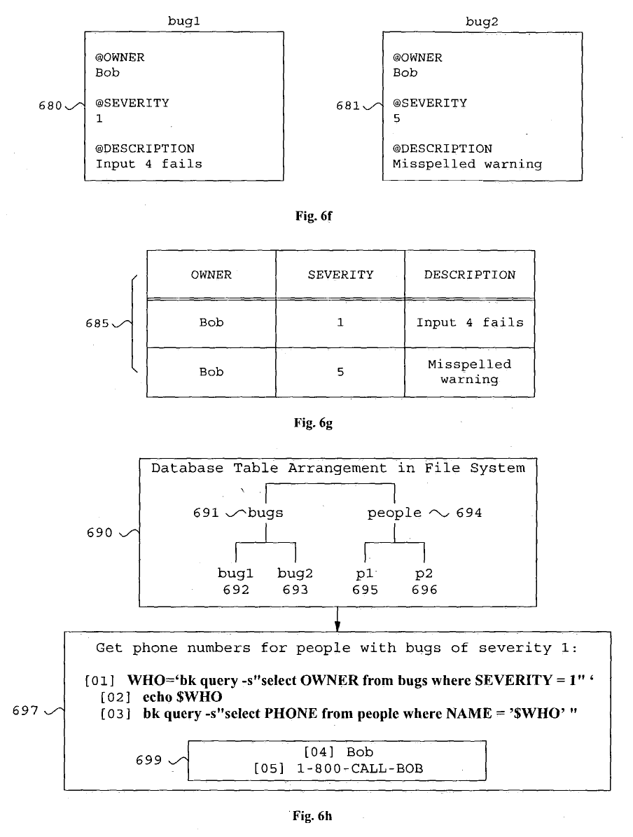

FIGS. 6a-6c shows an embodiment of the invention that provides for the organizing of data in a version controlled associative array to form a version controlled database table. Each version controlled file (600, 605) can be interpreted or structured as an associative array (610, 620) and may be viewed as a database record (640, 650). The column headings (632, 634, 636) are created from taking the union of the list of keys in each associative array. Each row (640, 650) corresponds to an associative array (610, 620). The contents of the row are the values in the associative array corresponding the key in the column heading. If a particular key does not exist in an associative array, as the key JOB (634) does not exist in (610), then the corresponding contents will be empty (644).

FIGS. 6d and 6e show an additional embodiment of the invention that includes a specification file that can be used to constrain the allowable entries in the database table, as well as filling in default values to use in the case where the associative array does not have a particular column heading key. For example in specification file (660), there is a line (005) which sets the default value of JOB to “Staff”. FIG. 6d corresponds to FIG. 6c with the addition of the default value (667).

FIGS. 6f, 6g and 6h show an additional embodiment of the invention that includes another table composed of a collection of associative arrays. FIG. 6f shows two associative arrays packaged in files, bug1 (680) and bug2 (681). FIG. 6g shows the corresponding database table (685). FIG. 6h shows an arrangement in the file system (690) where two directories represent two database tables. The bugs directory (691) contains the files (692, 693) from FIG. 6f. The people directory (694) contains the files (695, 696) from FIG. 6a. When given this arrangement, a query is executed (697). Line 1 reads all files recursively in the bugs directory (691) looking for the condition “SEVERITY=1” to be true. For all files found where it is true, the value of the OWNER is output. Line 2 outputs the query result from line1. Line 3 uses that result to recursively search all files it the people directory (694), and outputs the value of PHONE for all files that the query is true. The results are output in (699) with line 4 corresponding to line 2 and line 5 corresponding to line 3.

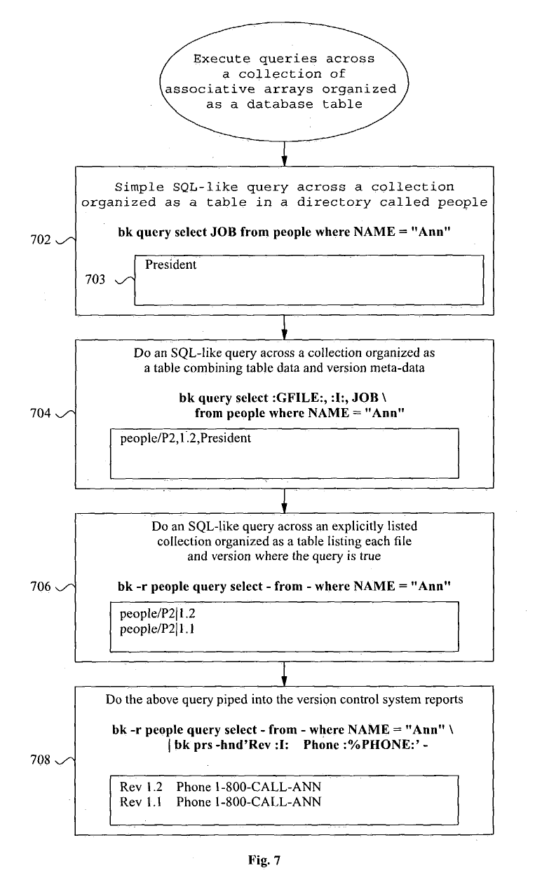

FIG. 7 shows an embodiment of the invention that includes queries performed across a collection or plurality of associative arrays organized as a database table. A simple query (702) takes the form similar to, for example, SQL (Structured Query Language) where the contents of columns are printed for rows that match the query. In this example, the column header is JOB, the collection of associative arrays is made up of the arrays stored in the directory ‘people’, and the condition matched is the value of the NAME column ‘Ann’. One embodiment of the invention provides for going through each associative array and providing outputs for the values for the specified keys if the query condition is met (703). A query report can mix version control metadata with database data (704). This example shows outputting the name of the file which holds the associative array, the revision of that file, and the value of the JOB column. The result is shown at (704). A query can also output the file and version in a format that can be received by the version control system's report command (706). This form can be given to the report command for more control over formatting the output (708). The example shows output with names and spaces (708) rather than a comma separated list (704).

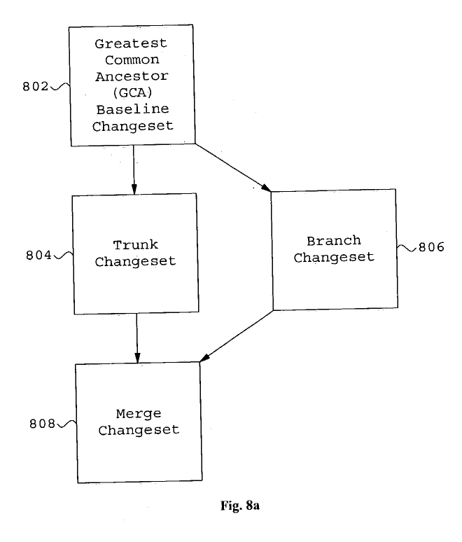

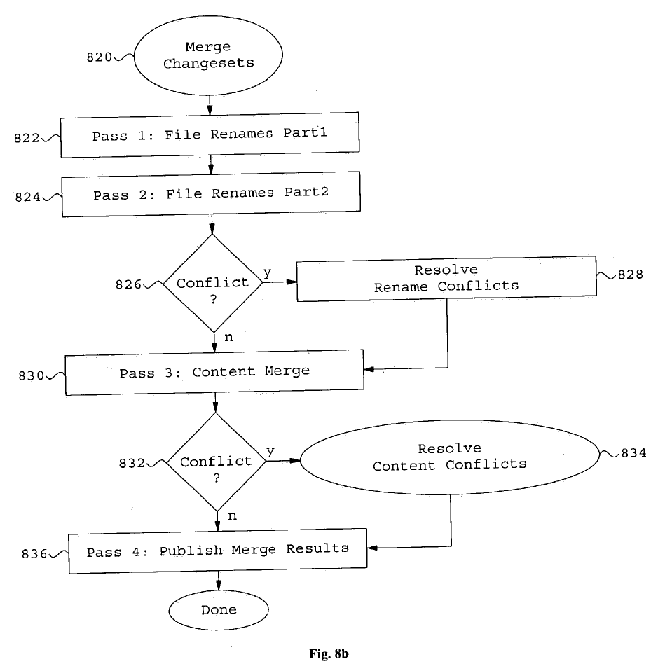

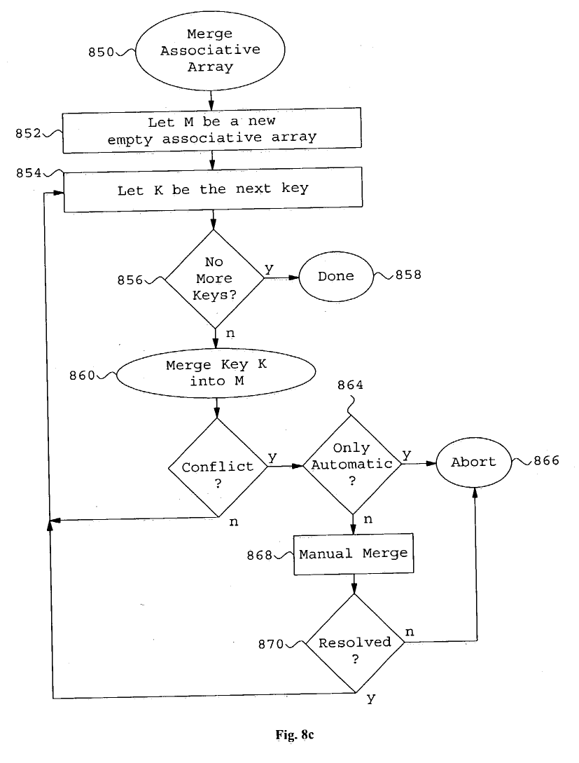

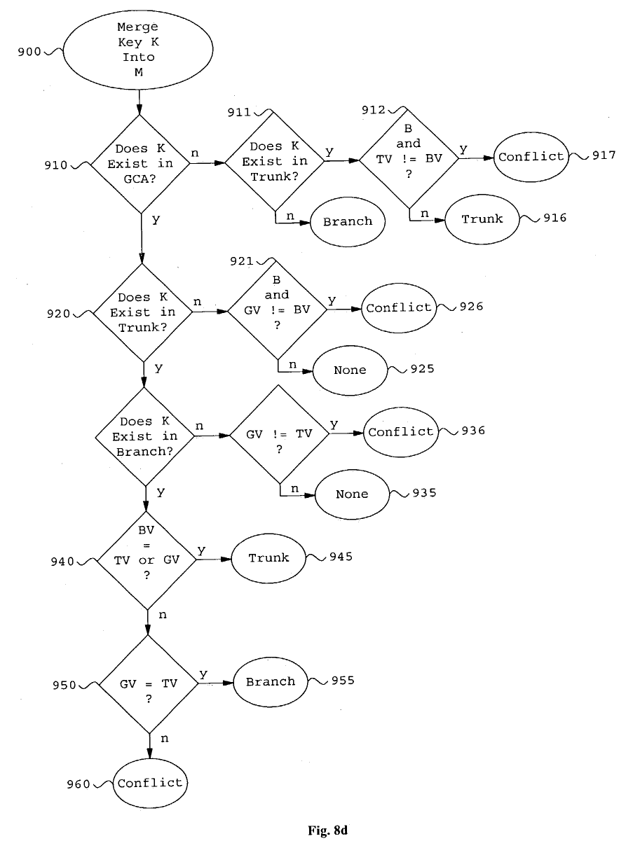

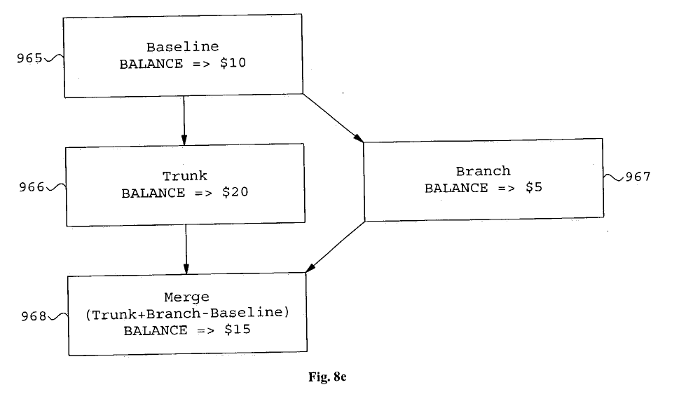

FIG. 8a shows an embodiment of the invention that includes the merging of independently made changesets to a baseline. Any changeset may function as a baseline (802). Independent changes (804, 806) are made according to, for example, the sequence illustrated in FIG. 5. The results are then merged (808) to produce a new baseline. In some cases, the merge fails due to unresolved conflicts, and the system is restored to the state it had before the merge was executed. It will be appreciated that an advantage of the present invention is that each changeset in FIG. 8a is a point that can be recovered. Each changeset records both the changes to files, and the versions of all the other files.

FIG. 8b shows an embodiment of the invention for a merge changeset (820) process. The steps (822, 824, 826, 828 and 830) are generally known and are not particular to the invention. What is particular to the invention is when both the Trunk (804) and the Branch (806) alter the same associative array. This results in a content conflict (832) to be resolved (834). If there are no problems, then the final result will get published as the merge result (836). It is possible for any step in this process (822-836) to fail, resulting in no merge result being published, and the system will be returned to the state it had before the merge was started.

FIG. 8c shows an embodiment of the invention that includes a process for merging conflicts in associative arrays (850). An empty associative array is initialized to hold the result (852). Then, a key may be obtained from a union of all keys in the Trunk, Branch, and Baseline versions (854). If there is no key left (856), then the process is done (858). Otherwise, key K is merged into M using a process detailed in FIG. 8d (860) and as will be described herein. If there is conflict at the key level, and the process is set to only handle automatic merging (864) then the merge process fails (866). Otherwise, a manual merge is done (868) where the user is presented the details of the merge, and selects to be the same as Trunk or Branch in regards to the key (absence or same value if present), or may choose to abort. If the manual merge resolves the merge for that key (870), then that key is done, and the next key is started (854). Otherwise the process is aborted (866).

FIG. 8d shows an embodiment of the invention for the process of merging associated with a particular key (900). It starts out to see if the key exists in the Greatest Common Ancestor (GCA) (910), which in the example is the baseline. If it does not, then a test is done to see if the key exists in the trunk (911). If it does not, then for key K, set the value in M to the same as in Branch. Even though it was not tested for existence, the key must exist in branch because the key exists in one of the 3 associative arrays, and it does not exist in two of them, so it must exist in the third. If the key does exist in the Trunk, then the key is tested to see if it exists in the Branch and if it does, that the value of the Trunk and Branch are not equal (912). If not, then set the value in M corresponding to key K to Trunk (916). Else this is a conflict where both Trunk and Branch added a new key K with different values (917). The user needs to decide what do to in this case. If the key K does exist in the GCA (910), then test if the key K exists in the Trunk (920). If not, test to see if the key exists in the Branch, and if it does, that the value in the GCA is not the same as the value in the Branch (921). If no, then do not put an entry in M for K (925), else there is a conflict (926) because the Trunk removed the key and the Branch changed the value associated with the key. The user needs to resolve what to do with this conflict. If the key K exists in both the GCA and the Trunk, check to see if it exists in the Branch (930). If not, test to see if the value in the GCA and the value in the Trunk are not equal. If yes, there is a conflict (936) similar to the previous conflict (926): the Branch removed a key from the associative array and the Trunk modified the key's corresponding value. This conflict needs to be resolved the user. If there the value in the GCA not different from the trunk, then do not add key K to the merge associative array M (935). If the key K exists in all 3 associative arrays (GCA, Trunk and Branch), then test to see if the Branch version is the same as the Trunk version or the GCA version (940). If it is the same, set the trunk value as the value corresponding to key K in M (945). Else test to see if the GCA value is the same as the Trunk value (950). If yes, then use the value of Branch as the value in M for key K (955). Else, there is a conflict (960). Both Trunk and Branch modified the value corresponding to key K. The user needs to resolve this conflict using, for example, methods described above in regards to FIG. 8c.

Referring to FIG. 8e, there is a special class of data that can be automatically merged even when the Trunk (966) and the Branch (967) change the value relative to the Baseline (965). An example of this type of data is money. The merge algorithm FIG. 8c (860) in this case would be the change done by the Trunk plus the change done by the Branch plus the Baseline, which reduces to Trunk plus Branch minus Baseline (968).

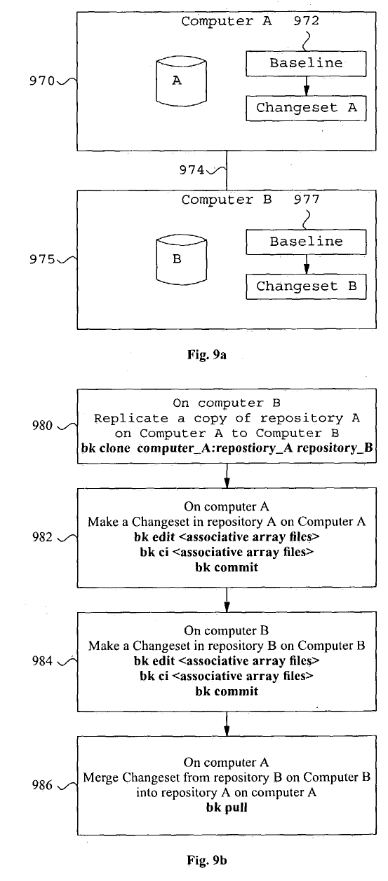

Referring to FIGS. 9a and 9b, there is illustrated an additional embodiment of the invention. In particular, FIG. 9a shows two user computers, A (970) and B (975), connected by a computer network (974) in any manner that is generally known. FIG. 9b shows a process where independent work can be done on each machine, then merged together. The process starts with replicating an existing repository on computer A onto computer B (980). Each computer now has a complete copy of the version control system repository. A changeset is made on each computer (982 and 984) according to, for example, the processes described in FIGS. 4 and 5. The history graph at this point in time in each machine is shown in FIG. 9a (972 and 977). The final step (986) uses the pull command to replicate changeset B from computer B to computer A, followed by a changeset merge process described, for example, in FIG. 8a.

Thus, it will be appreciated that a result of the invention is to version control structured data in the form of an associative array. In addition, it is a result of the invention to use that data structure to implement a database. The associative array may be used as a database record, multiple arrays may be combined into a database table, and multiple tables may be combined into a database. The database itself is built on a version control engine which may be replicated and modified in parallel, resulting in a database which may be replicated and modified in parallel. Each database is a peer of all other database replicas and may merge changes from any or all of the other replicas.

Coupling the handling of database tables with existing capabilities of advanced version control systems such as peer to peer replicated changesets with changeset granularity of rollback, and value of version controlling associative arrays is magnified into the value of building a geographically distributed version controlled database.

Whereas particular embodiments of this invention have been described above for purposes of illustration, it will be evident to those skilled in the art that numerous variations of the details of the present invention may be made without departing from the invention as defined in the appended claims.

What is claimed is:

1. On a computer capable of implementing version control, a method comprising:
providing a version control system on the computer;
creating within the version control system an associative array comprising a collection of keys and corresponding values; and
applying a version control operation to the associative array to version control the collection of keys and corresponding values.

2. The method of claim 1, wherein the version control operation includes at least one of add, create, edit, remove, modify, delete, commit, merge, rollback, query, delta or annotate.

3. The method of claim 1, further comprising structuring the associative array as a single file and version controlling the single file.

4. The method of claim 1, further comprising viewing an associative array as a database record.

5. The method of claim 1, further comprising organizing a collection of associative arrays as a database table.

6. The method of claim 5, further comprising a specification file which defines at least one of table characteristics default value or constraints on allowable values.

7. The method of claim 5, further comprising organizing a collection of database tables as a database.

8. The method of claim 5, further comprising applying a version control operation to the collection of associative arrays.

9. The method of claim 5, wherein the version control operation includes at least one of add, create, edit, remove, modify, delete, commit, merge, rollback, query, delta or annotate.

10. The method of claim 1, further comprising means for replicating at least a portion of the version control system.

11. The method of claim 1, further comprising means for structuring and arranging for peer to peer communication.

12. The method of claim 5, further comprising generating a report combining the associative array with other data and/or meta data contained within the version control system

13. The method of claim 1, further comprising automatically resolving a selected conflict occurring in the values of the associative array.

14. The method of claim 1, further comprising automatically resolving a selected conflict, using a merge algorithm having knowledge of the data, occurring in the values of the associative array.

15. The method of claim 1, further comprising manually resolving a selected conflict occurring in the keys by evaluating historical values of the keys containing the conflict.

16. The method of claim 1, further comprising version controlling a database containing the associative array.

17. The method of claim 11, wherein the version controlling of the database is performed utilizing replicated repositories of the version control system.

18. The method of claim 1, further comprising creating within the version control system a plurality of associative arrays.

19. The method of claim 18, further comprising:
replicating the plurality of associative arrays;
editing at least one of the plurality of associative arrays; and
committing the edited and unedited plurality of associative arrays back to the version control system.

20. The method of claim 19, further comprising version controlling the plurality of associative arrays in original form prior to the editing of at least one of the plurality of associative arrays.

21. The method of claim 19, further comprising version controlling the edited and unedited plurality of associative arrays following the committing of the edited and unedited plurality of associative arrays back to the version control system.

22. An apparatus for implementing version control, comprising:
means for providing a version control system;
means for creating within the version control system an associative array comprising a collection of keys and corresponding values; and
means for applying a version control operation to the associative array to version control the collection of keys and corresponding values.

23. The apparatus of claim 22, further comprising means for organizing a collection of associative arrays as a database table.

24. The apparatus of claim 22, further comprising means for operating the version control system within a peer-to-peer replicated network with another version control system.

25. A computer system capable of implementing version control, comprising:
a processor; and
a memory in communication with the processor, the memory having stored thereon a set of data and instructions including a version control system which, when executed by the processor, cause the processor to perform the steps of:
creating within the version control system an associative array comprising a collection of keys and corresponding values; and
applying a version control operation to the associative array to version control the collection of keys and corresponding values.

26. The computer system of claim 25, further comprising the processor performing the step of organizing a collection of associative arrays as a database table.

27. The computer system of claim 25, further comprising the processor performing the step of operating the version control system within a peer-to-peer replicated network with another version control system.

28. A computer system, comprising:
a first user computer comprising:
a first version control system accessible by the first user computer;
means for creating within the first version control system an associative array; and
means for applying a version control operation to the associative array;
a second user computer networked with the first user computer, each of the first user computer and the second user computer capable of operating independently in a peer to peer replicated environment, the second user computer comprising:
a second version control system accessible by the second user computer;
means for creating within the version control system an associative array; and
means for applying a version control operation to the associative array.

29. The system of claim 28, further comprising means for merging an edit made within the first version control system into the second version control system and vice-versa.

30. The system of claim 28, further comprising means for resolving a conflict that results from an edit made within either the first version control system or the second version control system.

31. The system of claim 28, further comprising means for organizing a collection of associative arrays as a database table in the first version control system.

32. The system of claim 28, further comprising means for organizing a collection of associative arrays as a database table in the second version control system.

33. A computer readable medium having stored thereon instructions which, when executed by a processor, cause the processor to perform the steps:
implementing a version control system on the computer readable medium;
creating within the version control system an associative array comprising a collection of keys and corresponding values; and
applying a version control operation to the associative array in order to version control the collection of keys and corresponding values.

34. The computer readable medium of claim 33, further comprising the processor performing the step of organizing a collection of associative arrays as a database table.

35. The computer readable medium of claim 33, further comprising the processor performing the step of operating the version control system within a peer-to-peer replicated network with another version control system.
